(19) United States
(12) Patent Application Publication
(10) Pub. No.: US 2003/0058538 A1
(43) Pub. Date: Mar. 27, 2003

(54) Diffraction grating, diffractive optical element, and optical system using the same

(76) Inventors: Takayuki Sugiyama, Tochigi (JP); Motomu Fukasawa, Saitama (JP)

Correspondence Address: FITZPATRICK CELLA HARPER & SCINTO, 30 ROCKEFELLER PLAZA, NEW YORK, NY, 10112, US

(21) Appl. No.: 10/252,041

(22) Filed: Sep. 23, 2002

(30) Foreign Application Priority Data
Sep. 25, 2001 (JP) 2001-292351

(51) Int. Cl. G02B 1/00

(52) U.S. Cl. 359/570; 359/558; 359/350

(57) ABSTRACT

An ultraviolet-permeable resin is used for a substrate of a diffraction grating, and at least one grating portion formed from ultraviolet cured resin is provided onto a surface of the substrate, thereby alleviating performance deterioration that is caused by heat expansion and the like due to environmental changes and enabling a large angle of view and cost reduction due to the simple construction. Further, a diffractive optical element using the diffraction grating, and an optical system using the diffractive optical element, are also obtained.

### BACKGROUND OF THE INVENTION

1. Field of the Invention

The present invention relates to a diffraction grating, a diffractive optical element, and an optical system using the same, being suitable for use in various types of optical systems such as, for example, exposure devices used in manufacturing devices, illumination systems, photographic cameras, binoculars, projectors, telescopes, microscopes, copying machines, and the like.

2. Description of Related Art

Conventionally, in order to correct (compensate for) chromatic aberration in optical systems, there has been a method in which glass members (lenses) formed of two materials exhibiting different types of dispersion are used in combination. In contrast to this method of reducing chromatic aberration by combining the lenses, methods using a diffractive optical element causing diffraction with respect to a lens surface or a part of an optical system have been disclosed in, for example, documents such as the publication “SPIE Vol. 1354 International Lens Design Conference (1990)”, and in Japanese Patent Application Laid-open No. 04-213421, Japanese Patent Application Laid-open No. 10-268116, Japanese Patent Application Laid-open No. 06-324262, U.S. Pat. No. 5,044,706, and the like. These methods take advantage of a physical phenomenon in which, between a refracting surface and a diffracting surface in the optical system, the chromatic aberration with respect to light rays of a given reference wavelength occurs in the opposite direction.

Further, in such diffractive optical elements, by changing intervals in the periodic structure of the diffraction gratings thereof, it becomes possible to impart the diffractive optical element with an aspheric characteristic, which is very effective for reducing the aberration. Here, a comparison of the refraction effect on light rays reveals the following: 1 light ray is kept as 1 light ray even after the refraction on the lens surface, while 1 light ray is divided up to respective orders when 1 light ray is diffracted in the diffraction grating.

Therefore, when the diffractive optical element is to be used in a lens system, the grating structure must be fixed so that the luminous fluxes at the wavelength region being used will be concentrated at a specific order. When the luminous fluxes at the specific order are concentrated, the intensity of other diffracted light rays becomes low, and when the intensity is 0, this means that there is no diffracted light. Therefore, in order to exhibit the above-mentioned properties, the intensity of diffracted light rays at the specific order need to be sufficiently high. Further, when there are light rays which exhibit diffraction orders other than the specified order, imaging takes place at places other than where the light rays at the given order are imaged, thus resulting in flares.

Therefore, in the optical system using the diffractive optical element, it is important to give sufficient consideration to the spectral distribution produced by the diffraction efficiency at the designed order and to the behavior of light rays other than those at the designed order.

FIG. 6 indicates the characteristic of the diffraction efficiency versus the diffraction order in a case where a diffraction grating 100 having a substrate 101 such as shown in FIG. 5 and a grating portion 102 composed of 1 layer which is provided on the substrate. In FIG. 6, the horizontal axis represents wavelength, and the vertical axis represents the diffraction efficiency.

The diffractive optical element is designed such that at a first-order diffraction order (the solid line in the diagram), the diffraction efficiency will be greatest at the wavelength region that is being used. In other words, the design order is the first order. Further, diffraction efficiencies at diffraction orders (i.e., a zero order and a second order, which are ±1 order away from the first order) which are near the design order are also shown in the diagram.

As shown in FIG. 6, at the design order, the diffraction efficiency becomes greatest at a given wavelength (e.g., 550 nm) (hereinafter, referred to as the “design wavelength”), and the diffraction efficiency becomes gradually lower at other wavelengths. The amount that the diffraction efficiency is reduced at the design order, becomes diffracted light at other orders and produces flares. Further, particularly in a case where a plurality of the diffraction gratings are used, the reduction of the diffraction efficiency at the wavelengths other than the design wavelength also contributes to a reduction in transmittance.

Various techniques have been proposed for diminishing the reduction of the diffraction efficiency, including: a multilayer-type diffractive optical element such as shown in FIG. 7, having a multilayer cross-sectional shape where a first grating portion 203 and a second grating portion 202 are layered one on top of the other; considering actual manufacturing, a multilayer-type diffractive optical element such as shown in FIG. 8, in which a first grating portion 213 and a second grating portion 214 are formed separately onto substrates 211 and 212, and are layered such that the grating pitches correspond with each other, with an air layer in between; a multilayer-type diffractive optical element such as shown in FIG. 9, in which a first and a second grating portion are both molded integrally with a substrate, and are layered on top of each other with an air layer in between; and a multilayer-type diffractive optical element such as shown in FIG. 10, in which only one of a first and second gratings is molded integrally with the substrate and they are laid on top of each other with an air layer between the gratings.

Note that, in each of the diagrams, reference numeral 100 denotes a diffraction grating; reference numeral 101 denotes a glass substrate; reference numeral 102 denotes a grating portion, which is replica-molded from an ultraviolet cured resin; reference numerals 201, 211, 212, and 232 each indicates a glass substrate; reference numerals 202, 203, 213, 214, and 233 each denotes a grating portion which is replica-molded from an ultraviolet cured resin; reference numerals 221, 222, and 231 each indicates a diffraction grating molded by means of injection molding; and reference numeral 215 denotes adhesive.

Further, grating thicknesses d₁ and d₂ thereof are determined by the following relational expression using refractive indices n1 and n2 of the optical elements and a reference wavelength λ0:

(n₁−1)d₁−(n₂−1)d₂=Mλ₀ (1)

This relational expression is a formula for optimizing the diffraction efficiency at which m-order light at a reference wavelength λ₀ is diffracted. The grating thicknesses d₁ and d₂ are determined so as to satisfy this relationship in the formula.

However, since the conventional diffraction grating 100 and the substrate of the diffractive optical element 200 shown in FIG. 5 and FIG. 7 are glass, there was a problem of costs.

Further, thermal expansion coefficients, namely the coefficients of linear expansion, of the glass used for the substrate and of the resin for molding the grating portion differed from each other on the order of 1 digit. Thus, there was a concern about performance deterioration caused by environmental changes.

Even in the multilayer-type diffractive optical element, since the diffractive optical element 210 shown in FIG. 8 is constituted by a combination of the diffraction grating shown in FIG. 5, the same problem occurred.

In the diffractive optical element 220 shown in FIG. 9, dispersion by resins which can be injection-molded is less than dispersion by resins which can be replica-molded. Therefore, when used in an optical system having a large angle of view, good performance could not be ensured across the entire range of visible light, and particularly at low wavelengths (i.e., near 400 nm). Further, in the diffractive optical element 230 shown in FIG. 10, the two substrates are glass and injection moldable resin. As such, there was a difference in their thermal expansion coefficients. Therefore, there was a problem of further performance deterioration in the substrates due to environmental changes.

### SUMMARY OF THE INVENTION

An object of the present invention is to provide a diffraction grating, a diffractive optical element, and an optical system using the same, in which, in a diffraction grating having a grating portion formed on a substrate, the substrate is replica-molded from an ultraviolet-permeable resin, and its grating portion is molded from an ultraviolet cured resin, thereby achieving a large angle of view, low cost (i.e., simple construction) and, less performance deterioration caused by environmental changes.

Another object of the present invention is to provide a diffraction grating in which an ultraviolet-permeable resin is used for a substrate, and at least one grating portions composed of an ultraviolet cured resin are provided onto a surface of the substrate.

A further object of the present invention is to provide a diffraction grating, characterized in that a thermal expansion coefficient of the substrate is 9.4×10⁻⁶ or greater and 1.1×10⁻⁴ or less.

A further object of the present invention is to provide a diffraction grating in which the substrate is made of an ultraviolet-permeable-type acrylic.

A further object of the present invention is to provide a diffraction grating in which the diffraction grating has a concave power, and dispersion by the material of the grating portion is 30 or less.

A further object of the present invention is to provide a diffraction grating in which the diffraction portion has a convex power, and dispersion by the material of the grating portion is 45 or greater.

A further object of the present invention is to provide a diffractive optical element wherein a plurality of diffraction gratings are arranged close to each other, the plurality of diffraction gratings including at least one diffraction gratings, in which an ultraviolet-permeable resin is used for a substrate, and at least one grating portions composed of an ultraviolet cured resin are provided onto a surface of the substrate.

A further object of the present invention is to provide a diffractive optical element in which at least two of the plurality of diffraction gratings are joined with their grating surfaces facing each other with a layer of air in between.

A further object of the present invention is to provide a diffractive optical element in which the plurality of diffraction gratings include at least: one diffraction grating having a concave power and in which dispersion by the material of the grating portion is 30 or less; and one diffraction grating having a convex power and in which dispersion by the material of the grating portion is 45 or greater.

A further object of the present invention is to provide a diffractive optical element, characterized in that a diffraction grating, in which an ultraviolet-permeable resin is used for a substrate, and at least one grating portions composed of an ultraviolet cured resin are provided onto a surface of the substrate, is provided on one side thereof, and a diffraction grating in which a substrate and its grating portion are integrally molded is provided on the other side thereof.

A further object of the present invention is to provide a diffractive optical element, in which the plurality of diffraction gratings are formed by molding a convex portion and a concave portion on the periphery of the substrate, and combining the convex portion and the concave portion to thereby stack a plurality of diffraction gratings.

A further object of the present invention is to provide a diffractive optical, in which the diffraction grating having its substrate and its grating portion integrally molded is molded by means of injection molding.

A further object of the present invention is to provide a diffractive optical element, in which the diffraction grating with its substrate and its grating portion integrally molded is made of plastic material.

A further object of the present invention is to provide a diffraction grating, characterized in that the substrate is one of a parallel flat plate and a member that has a curved surface.

A further object of the present invention is to provide a diffractive optical element, in which the substrate is one of a parallel flat plate and a member that has a curved surface.

A further object of the present invention is to provide an optical system using a diffraction grating in which an ultraviolet-permeable resin is used for a substrate, and at least one grating portions composed of an ultraviolet cured resin are provided onto a surface of the substrate.

A further object of the present invention is to provide an optical system using a diffractive optical element, characterized in that a plurality of diffraction gratings are arranged close to each other, the plurality of diffraction gratings including at least one diffraction gratings, in which an ultraviolet-permeable resin is used for a substrate, and at least one grating portions composed of an ultraviolet cured resin are provided onto a surface of the substrate.

A further object of the present invention is to provide an image reading device in which image information from an original is formed onto a surface of reading means using an image reading lens having a diffraction grating, in which an ultraviolet-permeable resin is used for a substrate, and at least one grating portions composed of an ultraviolet cured resin are provided onto a surface of the substrate.

A further object of the present invention is to provide an image reading device, characterized in that image information from an original is formed onto a surface of reading means using an image reading lens having a diffractive optical element, in which an ultraviolet-permeable resin is used for a substrate, and at least one grating portions composed of an ultraviolet cured resin are provided onto a surface of the substrate.

These and other objects and advantages of the invention may be readily be ascertained by referring to the following description and accompanying drawings.

### BRIEF DESCRIPTION OF THE DRAWINGS

In the accompanying drawings:

FIG. 1 illustrates a cross-sectional view of a main part of a diffraction grating according to the present invention;

FIG. 2 illustrates a cross-sectional view of a main part of Embodiment 1 of a diffractive optical element according to the present invention;

FIG. 3 illustrates a cross-sectional view of a main part of Embodiment 2 of a diffractive optical element according to the present invention;

FIG. 4 illustrates an outline diagram of an optical system using the diffractive optical element according to the present invention;

FIG. 5 presents an explanatory diagram of a conventional diffraction grating;

FIG. 6 presents an explanatory diagram of diffraction efficiency exhibited by a conventional diffractive optical element;

FIG. 7 presents an explanatory diagram of a conventional diffractive optical element;

FIG. 8 presents an explanatory diagram of another conventional diffractive optical element;

FIG. 9 presents an explanatory diagram of another conventional diffractive optical element;

FIG. 10 presents an explanatory diagram of another conventional diffractive optical element;

FIG. 11 shows an outline diagram of a main part of an image reading lens having a diffractive optical element, when applied in an image reading device; and

FIG. 12 shows an outline diagram of a main part of an image reading lens having a diffractive optical element, when applied in another image reading device.

### DETAILED DESCRIPTION OF THE PREFERRED EMBODIMENTS

### Embodiment 1

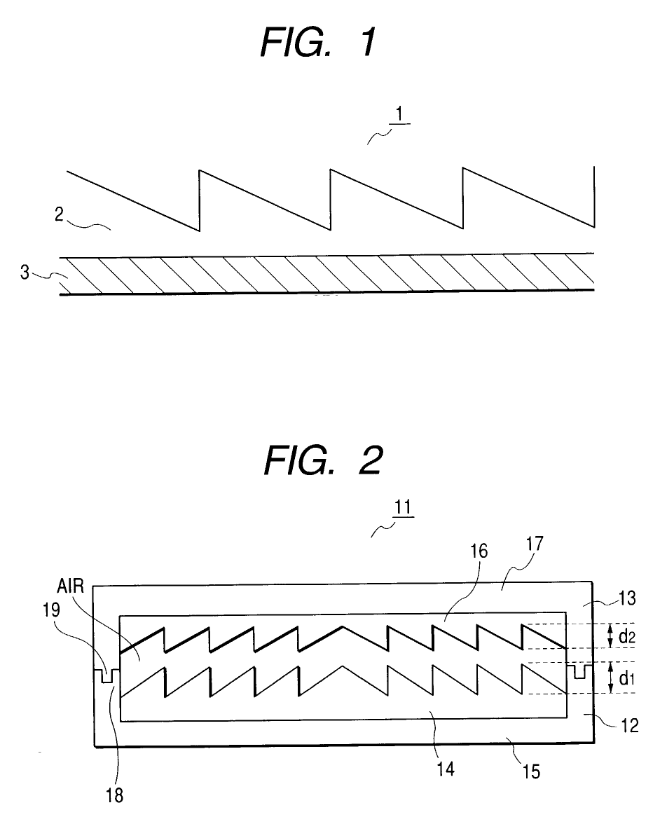

FIG. 1 is a cross-sectional diagram of a main part of Embodiment 1 of a diffraction grating according to the present invention. As shown in FIG. 1, a diffraction grating 1 is composed by forming a grating portion 2 on top of a substrate 3. The diagram is illustrated exaggerated in the depth direction of the grating of the grating portion 2.

The grating portion 2 is formed as a replica using an ultraviolet cured resin. The substrate 3 is constituted of a parallel flat plate and is molded from an ultraviolet-permeable resin. Note that, in this embodiment, the substrate is constituted by the parallel flat plate; however, the present invention is not limited to this configuration, and it may also be formed as a curved surface. Here, a linear expansion coefficient α of the substrate 3 satisfies the following conditional expression:

9.4×10⁻⁶≦α(cm/cm° C.)≦1.1×10⁻⁴

In other words, it is possible to use, for example, an ultraviolet-permeable-type acrylic having a nominal linear expansion coefficient of 7.0×10⁻⁵ (cm/cm° C.).

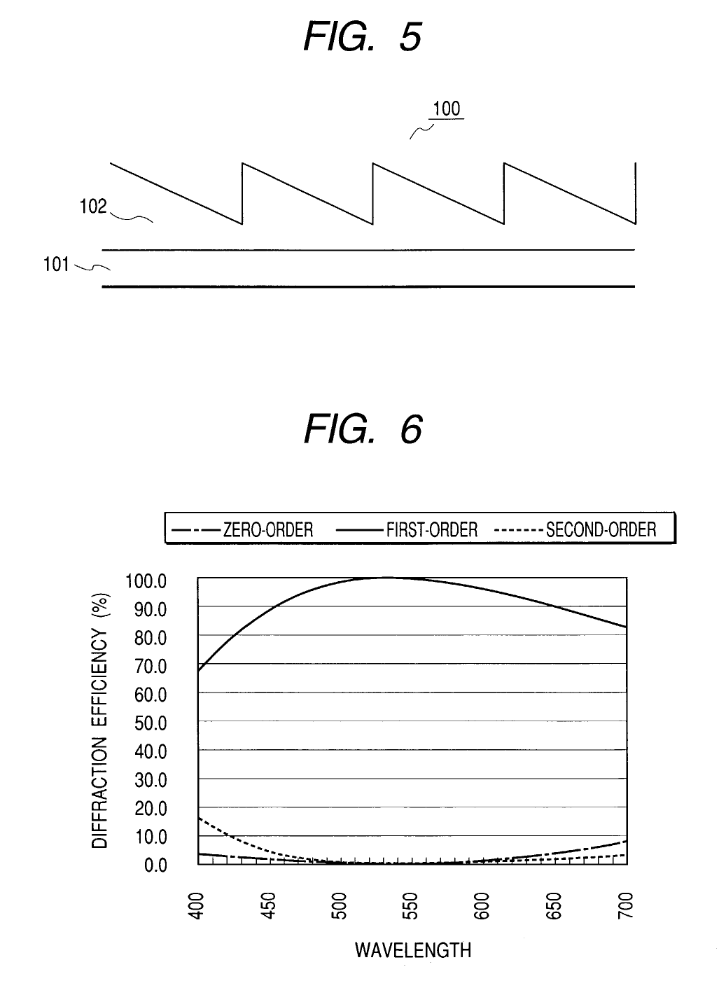

In a diffraction grating 100 according to a conventional example shown in FIG. 5, glass is used for a substrate 101. In contrast to this, this embodiment, the ultraviolet-permeable-type acrylic is used for the substrate 3, thereby making manufacturing thereof easier. Further, since the thermal expansion coefficients of the substrate 3 and the ultraviolet cured resin from which the grating portion 2 is molded are almost the same, it is possible to avoid performance deterioration occurring with material quality changes and shape deformations caused by environmental changes.

FIG. 2 is a cross-sectional diagram of a main portion of Embodiment 1 of a diffractive optical element using the diffraction grating according to the present invention. In FIG. 2, reference numeral 11 is a diffractive optical element composed of the following two grating portions arranged facing each other with an air layer in between: a first diffraction grating 12 acting as a convex lens (i.e., it converges light) and having a grating portion 14 replica-molded onto a substrate 15; and a second diffraction grating 13 with a grating pitch that is the same as the grating portion 14 but acting as a concave lens (i.e., it diverges light) and having a grating portion 16 replica-molded onto a substrate 7.

Note that, a transparent resin may be filled in between the first and the second diffraction gratings 12 and 13. Symbols d1 and d2 respectively denotes grating thicknesses of the first and the second diffraction gratings 12 and 13. The grating thicknesses are different form each other in the present invention, but there are instances where they are the same.

In accordance with this embodiment, as shown in FIG. 2, ultraviolet-permeable-type acrylic is used for the substrates 15 and 17, and ultraviolet cured resin is used to mold the grating portions 14 and 16 of the first and the second diffraction gratings 12 and 13, just like the construction shown in FIG. 1. This makes the manufacturing easier and prevents deterioration of performance by material quality changes, shape deformation, and the like of the substrates and the diffraction gratings due to environmental changes.

Further, the grating portion 14 of the first diffraction grating 12 is replica-molded from a material that is an ultraviolet cured resin having a dispersion of 45 or greater, and the grating portion 16 of the second diffraction grating 13 is replica-molded from a material that is an ultraviolet cured resin having a dispersion of 30 or less. Accordingly, a high diffraction efficiency can be obtained over the entire visible light range and over a large angle of view (with respect to luminous fluxes from various angles of incidence).

For example, in FIG. 2, for the grating portion 14 of the first diffraction grating 12, a product RC8922 (manufactured by DAINIPPON INK AND CHEMICALS, INCORPORATED) which is an ultraviolet cured resin exhibiting dispersion of 45 or greater is used, and for the grating portion 16 of the second diffraction grating 13, a product UV1000 (manufactured by MITSUBISHI CHEMICAL CORPORATION) which is an ultraviolet cured resin exhibiting dispersion of 30 or less is used. Therefore, in accordance with this embodiment, the grating portions 14 and 16 of the first and the second diffraction gratings 12 and 13 will have grating thicknesses of d₁=9.1 μm and d₂=6.4 μm according to the above-mentioned formula (1) expressing the relationship between the wavelength and the refractive index of the resin used to mold each of the grating portions 14 and 16 of the first and the second diffraction gratings 12 and 13.

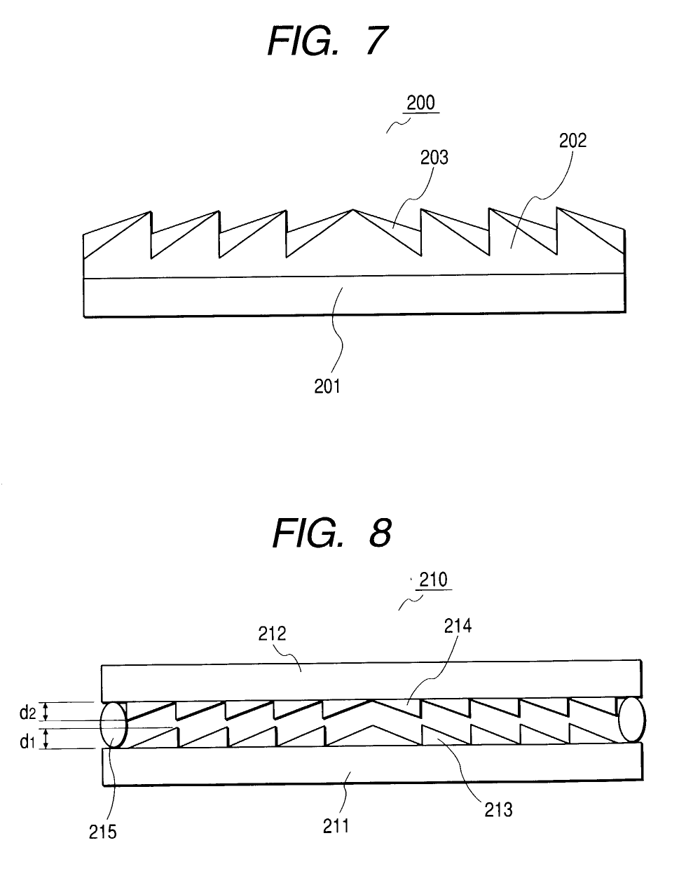

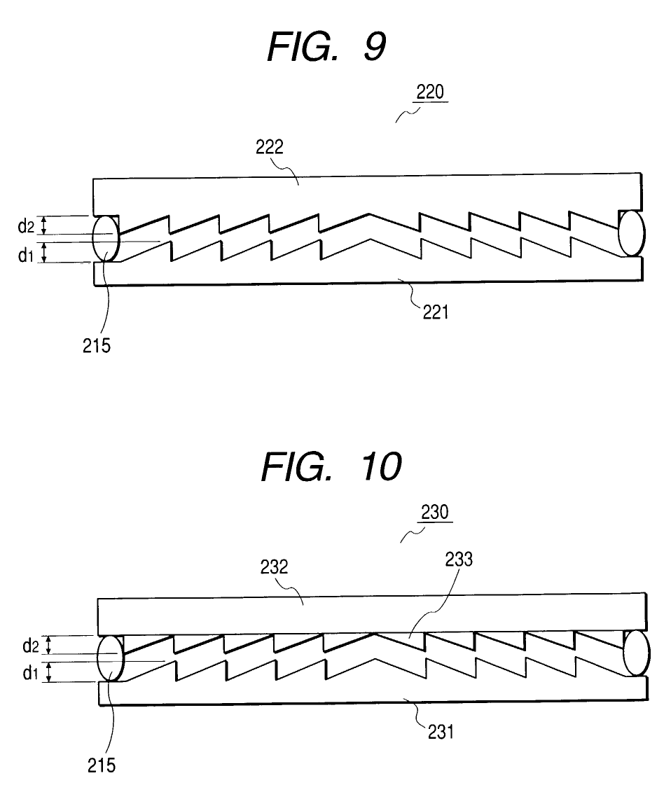

In accordance with this embodiment, a convex portion 18 and a concave portion 19 for stacking the first and the second diffraction gratings 12 and 13 are formed outside (peripheral part) the portion where the grating portions 14 and 16 are formed on each of the ultraviolet-permeable-type substrates 15 and 17 of the first and the second diffraction gratings 12 and 13. Conventionally, alignment marks were formed at the centers of the respective grating portions, and these were aligned with each other using a microscope, and then the glass substrates were joined by means of an adhesive. However, by forming the concave portion 18 and the convex portion 19 onto the substrates 15 and 17, the alignment process becomes easier. Note that, in accordance with this embodiment, one grating portion is provided on the substrate surface, but it is also possible to provided a plurality of these as shown in FIG. 7 mentioned above.

### Embodiment 2

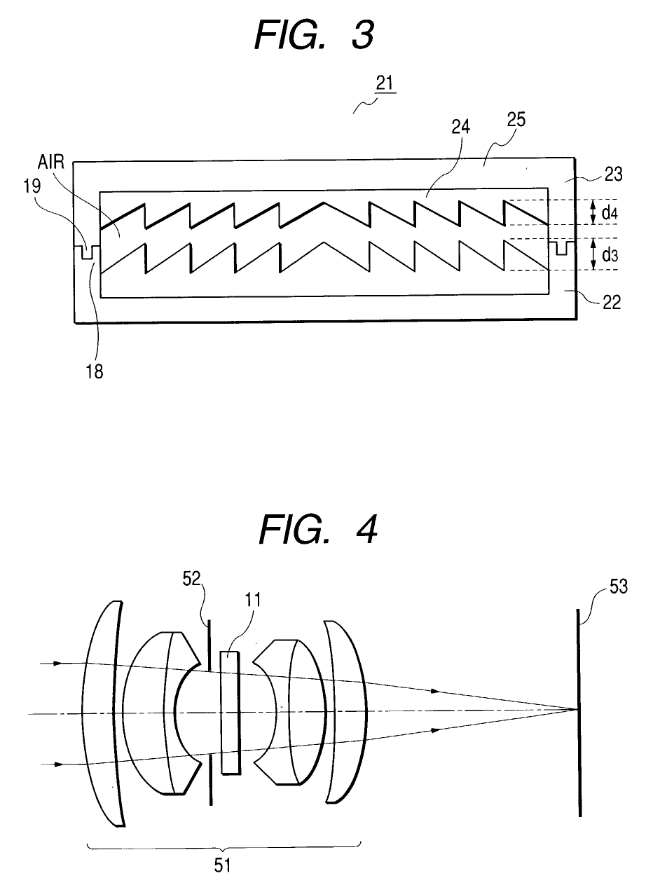

FIG. 3 is a cross-sectional diagram of a main portion of Embodiment 2 of a diffractive optical element using the diffraction grating according to the present invention. In FIG. 3, the same reference numerals are applied to the same elements as elements shown in FIG. 2. In this embodiment, a point which is different from the above-mentioned Embodiment 1 shown in FIG. 2 is that the first diffraction grating 22 is formed by molding the substrate and the grating portion in an integrated fashion by means of injection molding. Other constructional aspects and optical operations are substantially identical to Embodiment 1, and similar effects can be thus attained.

Namely, in FIG. 3, reference numeral 21 indicates a diffractive optical element which is composed of the following two grating portions arranged facing each other through an air layer: a first diffraction grating 22 having a convex power with the substrate and the grating portion being injection-molded in an integrated fashion, and a second diffraction grating 23 having the same grating pitch as the first diffraction grating 22 but having a concave power, with a grating portion 24 being replica-molded onto a substrate 25.

Note that the space between the first and the second grating portions 22 and 23 may be filled in with transparent resin. In the present invention, as for the second diffraction grating 1, the substrate 25 is formed from an ultraviolet-permeable-type acrylic, and the grating portion 24 is replica-molded using ultraviolet cured resin as in Embodiment 1, but the substrate and the grating portion of the first diffraction grating 22 are integrally formed by means of injection molding. With this arrangement, the manufacturing becomes even easier than Embodiment 1 since the optical element is not divided into 2 parts. Here, the substrate and the grating portion of the second diffraction grating 23 may also be integrally molded by injection molding, as in the first diffraction grating 22. Further, the molding is not restricted to injection molding, but mould molding may be used as well.

Further, since the substrates are both made of resin, the difference in thermal expansion rates that would be caused by the substrates is small. Therefore, it is possible to avoid performance deterioration caused by material changes and shape deformation due to environmental changes than can occur in the layers. Further, since the substrates are both made of resin, there may be formed outside the formed grating portions the convex portion 19 and the concave portion 18 for stacking the first and the second diffraction gratings 22 and 23, whereby obtaining the same effect as in Embodiment 1.

In accordance with this embodiment, for example, for the resin of the first diffraction grating 22, a product XEONEX (manufactured by ZEON corporation), which is a plastic optical material that can be injection-molded is used. For the material of the grating portion 24 of the second diffraction grating 23, a product UV1000 (manufactured by MITSUBISHI CHEMICAL CORPORATION), which is an ultraviolet cured resin with dispersion similar to Embodiment 1 of 30 or less is used.

Thus, according to the above-mentioned formula (1), the grating thicknesses d₃ and d₄ of the first and the second diffraction gratings 22 and 23 become d₃=8.2 μm and d₄=5.9 μm.

### Image Reading Lens

FIG. 4 is an outline diagram of a main part of Embodiment 1 of an optical system using the diffractive optical element (i.e., the diffraction grating) of the present invention. This embodiment shows a cross-sectional diagram of a lens applied as an image reading lens (i.e., a reader lens) of, for example, a digital color copying machine, a digital copying machine, a reader/printer, or the like.

Reference numeral 51 in the diagram denotes an image reading lens, inside which are provided a stop 52 and a diffractive optical element 11 according to the Embodiment 1 or Embodiment 2 described above. Reference numeral 53 denotes an image formation surface, and there is positioned an image pickup surface consisting of a CCD or other such image pickup means.

By using the diffractive optical element having the layered construction for the diffractive optical element 11, the problem of dependence upon the diffraction efficiency wavelength is largely improved, thereby achieving high-performance image reading lens with few flares and with high resolution at low frequency.

Further, the diffractive optical element of the present invention can be made with a simple manufacturing method. Therefore, an inexpensive lens system that is superior for mass production can be provided as the image reading lens.

Note that this embodiment illustrated an image reading lens for a digital color copying machine, a digital copying machine, a reader printer and the like, but the present invention is not limited to this embodiment. It can obtain the same effects when used as a photographic lens of a camera, a photographic lens of a video camera, an image scanner of a business machine, an exposure device for manufacturing semiconductor devices, or the like.

### Image Reading Device

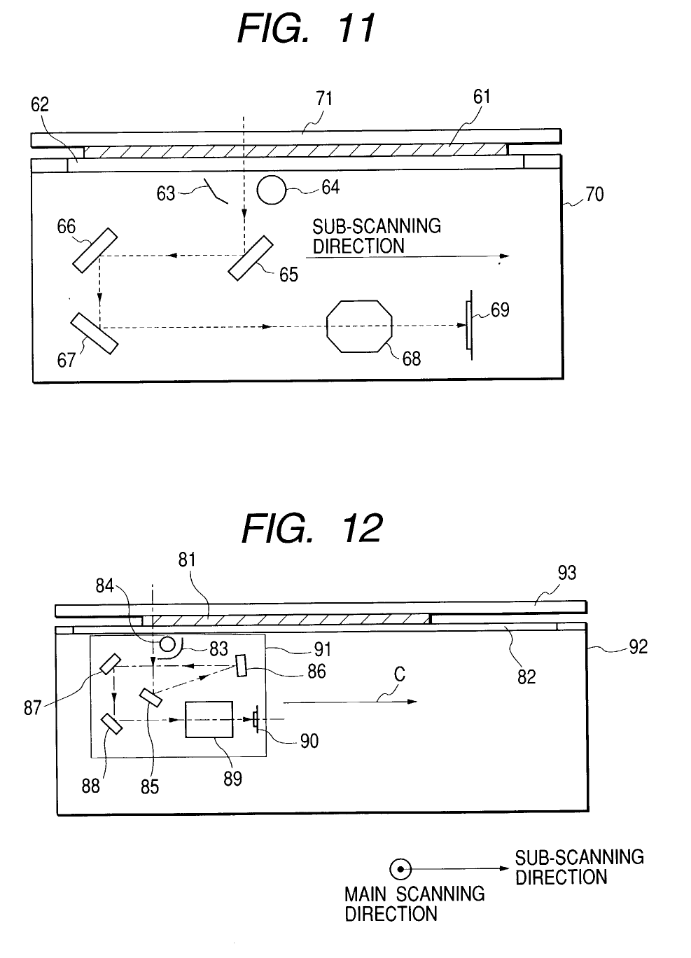

FIG. 11 is an outline diagram of a main part of Embodiment 1 when the image reading lens shown in FIG. 4 is applied in an image reading device of a digital color copying machine, a digital copying machine, a reader printer, or other such image reading device.

In FIG. 11, reference numeral 62 denotes original table glass, and an original 61 is placed on top of the glass surface. Reference numeral 64 denotes an illumination light source, composed of a halogen lamp, a fluorescent light, a xenon lamp or the like. Reference numeral 63 is a reflection shade (reflector) for reflecting the luminous flux from the illumination light source 64 so that the original 61 is illuminated efficiently. Reference numerals 65, 66 and 67 denote respectively a first, a second and a third reflection mirror for bending the optical path of the luminous flux form the original 61 inside a main body. Reference numeral 68 is the above-mentioned image reading lens (reader lens), which makes the luminous flux based on the image information of the original 61 form as an image on the surface of a reading means 69. Reference numeral 69 denotes a line sensor (CCD) serving as the reading means. Reference numeral 70 denotes a main body and 71 denotes a platen.

In this embodiment, the luminous flux radiated from the illumination light source 64 illuminates the original 61 either directly or via the reflection reflector 63, the reflected light from the original 61 reflects inside the main body by the reflection mirrors 65, 66 and 67 whereby the optical path of its luminous flux is bent, and then the image reading lens 68 forms the image therefrom on the surface of the CCD 69. At this time, while the first, the second and the third reflection mirrors 65, 66 and 67 move along a sub-scanning direction, scanning is performed electrically in a main scanning direction to read the image information from the original 61. At this time, the second and the third reflection mirrors 66 and 67 each move half of the distance that the first reflection mirror 65 moves, thereby maintaining a fixed distance between the original 61 and the CCD 69.

Note that, in this embodiment, the image reading lens was applied in the image reading device having the 1:2 scanning optical system. However, the present invention is not limited to this embodiment. For example, the present invention can also be applied in an integrated-type (i.e., flatbed-type) image reading device similarly to the Embodiment 1 described above.

In other words, in FIG. 12, the luminous flux emitted from illumination means 84 illuminates an original 81 directly or via a reflection umbrella 83, and the reflected luminous flux from the original 81 reflects by first, second, third and fourth reflection mirrors 85, 86, 87 and 88 whereby its optical path is bent inside a carriage 91, and an image reading lens 89 forms an image on the surface of a CCD linear image sensor or other such linear image sensor 90 (hereinafter referred to as the “CCD”). Then, the carriage 91 is moved by means of a sub-scanning motor (not shown in the diagram) along a direction of an arrow C shown in the diagram, whereby the image information of the original is read. The CCD 90 in FIG. 12 is formed according to a construction in which a plurality of light-receiving elements are arranged along the linear direction (i.e., the main scanning direction).

Note that, in accordance with this embodiment, the image reading lens is applied in a digital color copying machine, a digital copying machine, a reader printer or other such image reading device. However, the present invention is not limited to this embodiment. A similar effect can be obtained even when used in an photographic lens of a camera, an photographic lens of a video camera, an image scanner in a business machine, an exposure device for manufacturing semiconductor devices, and the like.

In accordance with the present invention, in the diffraction grating with the grating portion formed on the substrate as described above, the substrate is replica-molded with ultraviolet-permeable resin, and the grating portion is replica-molded using the ultraviolet cured resin. As such, it becomes possible to achieve the diffraction grating, the diffractive optical element and the optical system which uses the same, which have a large angles of view and involve low costs (i.e., simple construction), and in which performance deterioration due to environmental changes is improved.

While the described embodiment represents the preferred from the present invention, it is to be understood that modifications will occur to those skilled in that art without departing from the spirit of the invention. The scope of the invention is therefore to be determined solely by the appended claims.

What is claimed is:

1. A diffraction grating wherein an ultraviolet-permeable resin is used for a substrate, and at least one grating portions comprising of an ultraviolet cured resin and being provided onto a surface of the substrate.

2. A diffraction grating according to claim 1, wherein a thermal expansion coefficient of the substrate is 9.4×10⁻⁶ (cm/cm° C.) or greater and 1.1×10⁻⁴ (cm/cm° C.) or less.

3. A diffraction grating according to claim 1, wherein the substrate is made of an ultraviolet-permeable-type acrylic.

4. A diffraction grating according to claim 1, wherein the diffraction grating has a concave power, and dispersion by the material of the grating portion is 30 or less.

5. A diffraction grating according to claim 1, wherein the diffraction portion has a convex power, and dispersion by the material of the grating portion is 45 or greater.

6. A diffractive optical element in which a plurality of diffraction gratings including at least one diffraction gratings as set forth in claim 1 are arranged close to each other.

7. A diffractive optical element according to claim 6, wherein at least two of the plurality of diffraction gratings are joined with their grating surfaces facing each other with a layer of air in between.

8. A diffractive optical element according to claim 6, wherein the plurality of diffraction gratings include at least: one diffraction grating having a concave power and in which dispersion by the material of the grating portion is 30 or less; and one diffraction grating having a convex power and in which dispersion by the material of the grating portion is 45 or greater.

9. A diffractive optical element in which a diffraction grating as set forth in claim 1 is provided on one side thereof, and a diffraction grating in which a substrate and its grating portion are integrally molded is provided on the other side thereof.

10. A diffractive optical element according to claim 6, wherein the plurality of diffraction gratings are formed by molding a convex portion and a concave portion on the periphery of the substrate, and combining the convex portion and the concave portion to thereby stack a plurality of diffraction gratings.

11. A diffractive optical element according to claim 9, wherein the diffraction grating is integrally molded with a substrate and grating portion therein by means of injection molding.

12. A diffractive optical element according to claim 9, wherein the diffraction grating with its substrate and its grating portion integrally molded is made of plastic material.

13. A diffraction grating according to claim 1, wherein the substrate is one of a parallel flat plate and a member that has a curved surface.

14. A diffractive optical element according to claim 6, wherein the substrate is one of a parallel flat plate and a member that has a curved surface.

15. An optical system using a diffraction grating as set forth in claim 1.

16. An optical system using a diffractive optical element as set forth in claim 6.

17. An image reading device in which image information from an original is formed onto a surface of reading means using an image reading lens having a diffraction grating as set forth in claim 1.

18. An image reading device in which image information from an original is formed onto a surface of reading means using an image reading lens having a diffractive optical element as set forth in claim 6.
